(19) United States
(12) Patent Application Publication
(10) Pub. No.: US 2006/0191323 A1
(43) Pub. Date: Aug. 31, 2006

(54) Automated system for detection and control of water leaks, gas leaks, and other building problems

(76) Inventors: Michael Garabedian, Newton, MA (US); Patrick Garabedian, Rutland, MA (US)

Correspondence Address: LAW OFFICE OF BRETT N. DORNY, 386 WEST MAIN STREET, SUITE 12A, NORTHBOROUGH, MA, 01532, US

(21) Appl. No.: 11/065,864

(22) Filed: Feb. 25, 2005

(51) Int. Cl. G01M 3/04

(52) U.S. Cl. 73/40; 340/605

(57) ABSTRACT

A leak detection system performs actions based upon the type and location of the detected leak. A plurality of sensors and sensor types are used at various locations in a building where leaks are likely to occur. Upon detection of a leak, a sensor transmits an RF signal identifying the sensor. A controller receives the RF signal and performs actions associated with the identifier for the sensor. Actions may include selectively closing or opening valves and electrical connections. Notifications are also sent by the system to building owners or occupants.

### BACKGROUND OF THE INVENTION

1. Field of the Invention

The present invention relates to a system for detecting water leaks, gas leaks and other building problems and automatically acting to prevent significant damage. More particularly, it relates to a system for monitoring multiple locations and selective control of building devices based upon detected leak locations.

2. Discussion of Related Art

Buildings include networks pipes, valves, and other mechanized devices for conveying liquids and/or gases, such as water, oil, natural gas, and propane. The parts in these networks often require periodic maintenance. Not infrequently, there is a malfunction and undesirable water, gas or other substances leak into the building. These leaks present a health hazard to the occupants and cause significant damage to the building and its contents. The type and location of a malfunction or failure cannot be predetermined. Thus, in order to limit damage and the safety hazard, a leak needs to be responded to, stopped, and cleaned up quickly. Often, the occurrence of a leak is not noticed until sufficient water or other substance has accumulated in an occupied area. Since the network of pipes is generally located out of sight, a substantial leak, with accompanying damage, will have occurred before its occurrence is detected. An appropriate response often includes an expensive, emergency visit from a plumber or other service professional to correct any problems.

In addition to the network of pipes, the liquids or gases terminate at various fixtures and appliacnces. Such fixtures and appliances include hot water heaters, washing machines, dishwashers, radiators, sinks, commodes, ovens, stoves, fireplaces, refrigerators, etc. Failures also occur at the fixture or appliance which also may cause a leak. Failures within the network are often caused by ambient conditions which cause the water in certain pipes, such as pipes extending through or along poorly-insulated outside walls, to freeze, bursting the pipes. Serious flooding is also often caused by inadvertently leaving a faucet in a sink or tub running with the associated drain blocked.

Additionally, in buildings which are heated, there is a constant danger that lethal carbon monoxide will be generated from improper combustion of the fuel source. Carbon monoxide has no odor and is not typically detected by building occupants.

A quick response to a leak or other problem can significantly limit the damage. Thus, automated systems have been developed to detect and respond to leaks. Such systems include one or more sensors placed at a location of a likely leak. The sensors may activate a visual or audio alarm located at the sensor or at a remote location. Such system may also respond to detected leaks by shutting off valves to prevent further flow of the liquid or gas to the area of the leak.

While the occurrence of a leak cannot be predicted, locations where leaks are likely to occur can be predicted. For example, sensors can be placed near or under appliances likely to develop leaking conditions, under pipes extending through or near exterior walls likely to promote freezing conditions, and at low points in bathrooms where sinks and tubs may be left with water running. While the locations of potential leaks can be determined, some of these locations, such as the places where pipes run through or near exterior walls, are not easily accessed. Such locations may, for example, be in crawl spaces under floors or in attics. Thus, sensing systems generally account for the difficulties in sensor placement, leak response locations, alarm placement, etc. A number of patents relate to different types of systems and features useful in detecting and responding to leaks.

U.S. Pat. No. 4,134,022, issued to Honeywell, U.S.A., discloses a liquid level sensing apparatus that has a source for supplying a signal of a predetermined frequency. A level sensor is connected to the source and has an output for signalling an output signal which has the predetermined frequency, so long as the level of the material being sensed is not at a predetermined level. The apparatus includes a frequency sensitive circuit for receiving the output signal from the level sensor and for providing an output whenever the frequency of the signal is above or below the predetermined frequency. A load which is responsive to the output from the frequency sensitive circuit is connected to the circuit. This system is solely for detecting a leak at various locations and providing an indication of the leak. It does not automatically respond to the leak to prevent damage.

U.S. Pat. No. 5,240,022, issued to Franklin, discloses an automatic shut-off valve system for installation, for instance, in the water supply line to a hot water heater. It includes a sensor to detect leakage electrically by sensing moisture, and shuts off the supply line in response. The valve mechanism includes a spring loaded ball valve normally latched in the open position which is unlatched and hence closes by the contraction of a wire which activates a torsion spring to rotate the ball valve. The valve is controlled by a microprocessor which includes self test features. The valve system may operate for a year or more on battery power.

U.S. Pat. No. 4,324,268 to Jacobson describes an automatic flood control valve apparatus having a normally open valve in combination with a latching relay for closing the valve, which latches the valve in a closed position when the relay is energized and until it is manually reset, and a single transistor sensor circuit for energizing the relay in response to a water leak. A pair of sensing electrodes is extended in two directions to detect water leaks adjacent to two different appliances. Electrical power is shown as coming only from the AC lines. However, this method requires hard wired connections to each area in which leaks are to be sensed. In general, many of such locations cannot be easily reached with wiring. Furthermore, when a water leak is detected, this method lacks a way to determine which location is affected.

In U.S. Pat. No. 5,229,750, Welch et al. teach a leak sensor consisting of solenoid valves for shutting off the water supply and for draining water tanks through discharge lines to the outside of a building and the like, and for simultaneously shutting off the power. The Welch sensor has a float with a metal cap, two pair of electrical probes or conductors placed on opposite sides of the float. When a water leak is detected, an inlet valve is shut and an outlet valve is opened thereby releasing stored water to the outside.

Akiba, in U.S. Pat. No. 4,843,305, discloses an apparatus for sensing leaks in water pipes based upon the conductivity of spaced-apart pairs of insulated conductors which are wrapped around the pipe. With this sensor, leaking water may not always establish contact with all exposed areas of the insulated conductors, or that leaking water may not adhere to the conductors, thereby obviously failing to signal a leak. Similar to the Akiba apparatus, in U.S. Pat. No. 4,374,379, Dennison teaches a moisture sensing apparatus for pipes that also uses a pair of spaced-apart electrical conductors partially positioned in an elongated flexible insulator which is circumferentially affixed to such pipe. The partially exposed electrical connectors are oppositely disposed relative to the pipe. An alarm actuating circuit is interconnected with the conductors and configured to initiate an alarm when water bridges the closely spaced conductors, It appears that this apparatus is insensitive to small leaks because water droplets are unable to bridge the sensing electrode gap disposed on the opposite sides of the sensor assembly.

Hinkle discloses, in U.S. Pat. No. 4,090,193, a water leak detection apparatus which used frequency multiplexing to sense the location of leaks. Sensing circuitry comprises a master indicator circuit and a plurality of satellite leak detectors for simultaneously monitoring these detectors based upon their unique frequency warning signal. The indicator circuit isolates and displays the leak location based upon the warning signal.

A fluid leak detector disclosed by Lawson in U.S. Pat. No. 5,637,789 is intended for downstream leak detection in residential pipelines. It detects extraneous fluid flow over a predetermined time interval by means of thermal transport using a thermistor. This device suffers from being susceptible to malfunctions due to corrosion, hard water, and the like, and from being dependent upon a fine temperature differential, that, in turn, requires a high sensitivity which is inherently adversely affected by the thermistor itself Furthermore, in order to obtain reasonable leak detection performance over a protracted period of time, the device must be calibrated from season to season.

The patent literature also describes a number of systems configured to sense a water leak in a single area and to turn off a source of water to the device causing the spill. U.S. Pat. No. 4,845,472 to Gorden et al. describes the use of a single sensor at the low point of a basement, with the input water pipe being shut off by a valve. U.S. Pat. No. 5,344,973 to Furr and U.S. Pat. No. 5,345,224 to Brown describe leak detection systems configured for use with water heaters. U.S. Pat. No. 5,357,241 to Welsh, Jr. et al. describes a system for use with either the water tank of a hot water heater or the water tank of a toilet. When a leak is detected, a first valve is closed to prevent the flow of additional water into the tank, and a second valve is opened to drain water from the tank. Since water leaks can occur in so many places within a typical structure, what is needed is a system having a single valve to shut off the water, operated when a leak is detected at one of a number of different sensor locations.

U.S. Pat. No. 5,655,561 to Wendel discloses a water-activated alarm system which utilized RF transmitters and receivers. Sensors are connected to an alarm including an RF transmitter. Upon detection of a leak, audible and visual alarms are activated at the sensor location. An RF signal is also transmitted. A RF receiver is part of a control device placed at a remote location from the sensor. The control device includes a solenoid valve, activated by receipt of the RF signal, to shut off the flow of water.

Diduck, U.S. Pat. No. 6,025,788, discloses an integrated leak detection and shut-off system. Similar to Wendel, the Diduck system includes a sensor for detecting a leak. The system can be used for liquids or gas and has different types of sensors. The sensor sends a signal to a remote control device for shutting off the flow of water or gas to stop the leak. Diduck further discloses the use of multiple sensors at different locations of possible leaks. A leak detected at any of the sensors causes the control device to shut off the liquid or gas flow.

One of the difficulties with the system disclosed in Diduck is that once the valve is shut off, the location of the leak remains unknown. In earlier systems, a single sensor was used. With multiple sensors, the location of the leak which resulted in the shut-off must be determined. U.S. Pat. No. 6,526,807 to Doumit discloses a sensor system with a control panel indicating the location of an activated sensor. The location and/or type of leak can be determined from indicators on the control panel.

While many different sensor and control systems are known and disclosed in the patent literature, none of such systems provide complete protection under a variety of conditions. In particular, all such systems include one or more sensors for detecting leaks and provide a single response to a detected leak. The response may include a set of different types of actions, such as activation of different types of alarms, indications of locations, and activation of valves to stop leaks. Nevertheless, known systems are limited to a single predetermined response to all detected conditions. They cannot provide alternative responses based upon the type or location of a sensor detecting a leak.

### SUMMARY OF THE INVENTION

The present invention is a automated system for responding to different types of detected leaks. It includes a plurality of sensors at locations of possible leaks. The sensors transmit signals upon leak detection. A control device receives the transmitted signal and determines an appropriate response to the detected leak. The control device functions to perform the desired response. According to aspects of the invention, the functions may include combinations of shutting off water or gas valves, turning off electrical devices, activating pumps, activating alarms, and notifying users, owners, or repairmen of the detected leak. According to an aspect of the invention, the system includes an autodialer for telephoning predetermined numbers upon leak detection and playing a message. Different telephone numbers and messages are uses for different detected leaks.

According to another aspect of the invention, the system includes a variety of sensors and sensor types. Such sensors including water sensors, gas sensors, carbon monoxide sensors, and temperature sensors. Different types of sensor leads, such as cable sensors, fabric tape sensors, and stainless steel tape sensors may also be used.

According to another aspect of the invention, signals from the sensors to the control device are sent using RF transmissions. According to other aspects of the invention, wire or optical cabling are used to send signals from the sensors to the control device.

According to another aspect of the invention, the control device is used to reset alarms and valves. The control device includes multiple switches for independent operation of valves and alarms. Thus, an alarm may be deactivated without the need to reopen a valve closed to prevent a leak.

According to another aspect of the invention, the system includes a control signal splitter for performing multiple operations from a single control signal. A control signal is output by the control device to close valves. Under some conditions, other actions, such as shutting off electrical power must be done when the valve is shut off. The control signal splitter provides the control signal to the valve activator and to a relay for turning off electrical power.

### BRIEF DESCRIPTION OF THE DRAWINGS

FIG. 1 illustrates a leak detection and control system according to an embodiment of the present invention.

FIGS. 2A-2D illustrate different embodiments of sensor leads in connection with a leak detection and control system.

FIG. 3 is a block diagram of the components of a sensor according to an embodiment of the present invention.

FIG. 4 is a block diagram of the components of a controller according to an embodiment of the present invention.

FIG. 5 illustrates a control output according to an embodiment of the present invention.

### DETAILED DESCRIPTION

The present invention is a “smart” system allowing multiple possible responses to detection of leaks. In prior art systems, only a single prescribed response was possible. The response could include multiple actions, such as activating an alarm and shutting off a valve, but such systems could not selective perform actions. Thus, prior art systems were limited to implementations which protected against a single type of leak. Such a system cannot provide the flexibility necessary for a complete protection system or for multiunit buildings. The present invention provides greater flexibility through selection of responses based upon the type and location of detected leaks.

According to an embodiment of the invention illustrated in FIG. 1, the system 10 includes two types of devices, a plurality of sensors 20 (one shown) and a controller 30. The sensors 20 are placed at locations of possible leaks. The controller 30 is placed remotely from the sensors and preferably at locations where responsive actions should be taken, such as in a basement where shut-off valves are located. When the sensors 20 detect a leak, they send a signal to the controller 30. Upon receipt of a signal from a sensor 20, the controller 30 takes appropriate action.

The sensors 20 include a power source and electronics in a housing 28. Preferably, the housing 28 is water tight to protect the components of the sensor 20 from leaks. Of course, if the sensor 20 is used for sensing leaks of other liquids or gases, the housing 28 should be impervious to such liquids or gases. A sensor lead 21 extends from the housing 28. The sensor lead 21 may be wired directly into the housing 28. According to a preferred embodiment of the invention, the sensor lead 21 connects to a port 29 in the sensor 20. By using a port 29 in the sensor 20, different types of sensor leads 21 may be used in connection with a sensor to provide for different types of leak detection without the need for multiple kinds of sensors. According to an embodiment of the invention, the sensors 20 are of a type which detects a leak through completion of an electrical circuit. The output port 29 includes two connectors. Completion of an electrical circuit between the two connectors indicates the presence of a leak. The sensor lead 21 operates to complete the electrical circuit as the result of a leak or other sensed event.

The sensor lead 21 illustrated in FIG. 1 includes a detector tip 22 which creates a water leak detector. The detector tip 22 includes two electrodes 22a, 22b. Wires in the lead 21 connect each of the electrodes 22a, 22b to the two connectors of the port 29. The detector tip 22 is positioned at a location where a water leak may occur. The electrodes 22a, 22b are positioned so that they will contact water from the leak. The leaking water provides the electrical connection between the electrodes 22a, 22b which completes the electrical circuit from the sensor. The lead 21 is of sufficient length so that the lead can be easily positioned at a water leak location. Sensor leads 20 may have different lengths for different applications. Preferably, the sensor 20 is mounted on a wall or in a crawl space near a location of a possible leak. Since the housing 28 is water tight, the positioning of the sensor 20 need not be out of the area where a leak occurs.

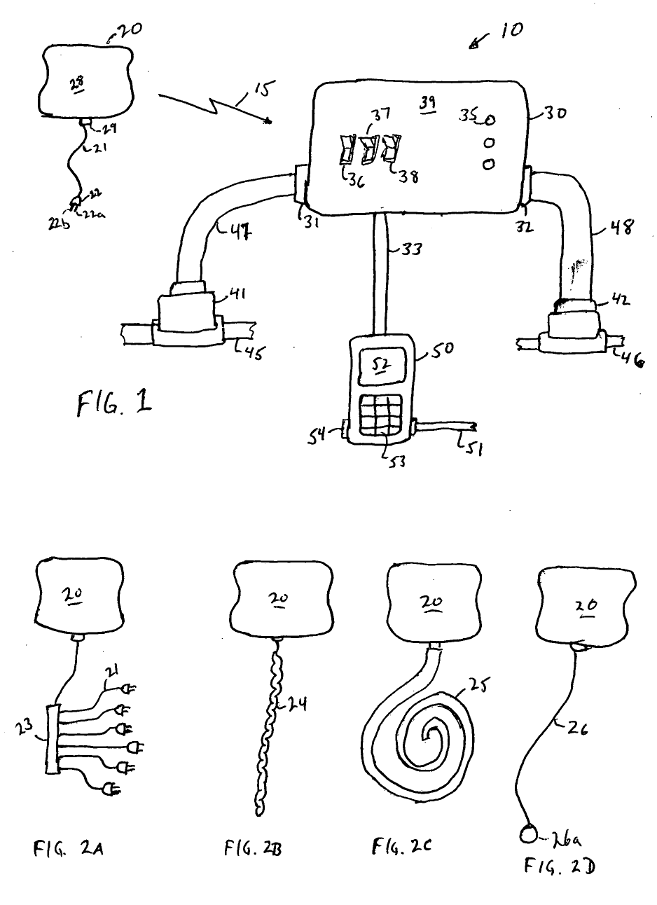

According to an embodiment of the invention, different sensor leads 21 may be used with a sensor 20 to provide for detection of different types of leaks or conditions. FIGS. 2A-2D illustrate various possible sensor lead configurations. Of course, the sensor leads shown in FIGS. 2A-2D are merely representative of the possibilities with the present invention. Any type of lead or sensor may be used for detection purposes.

FIG. 2A illustrates a water sensor for detecting leaks at multiple locations. The sensor 20 is connected to a lead splitter 23. Sensor leads 21 are connected to the lead splitter 23. As with the sensor 20 itself, the sensor leads 21 may be a single unit with the lead splitter 23 or may be removably attached to lead splitter 23. The lead splitter is wired so that the electrical circuit in the sensor 20 is completed if any of the leads 21 detect water. FIG. 2A illustrates a lead splitter 23 into which six leads 21 can be connected. Lead splitters 23 may be cascaded to allow connection of more leads 21. Furthermore, while FIG. 2A illustrates the lead splitter 23 being connected to water sensor leads 21, any type of lead may be connected to the lead splitter 23 or different lead types may be combined in the lead splitter 23.

FIGS. 2B-2D illustrate different types of sensor leads which may be used in the present invention. Cable sensor leads 24 and tape sensor leads 25 are used to provide for detection of leaks anywhere along a length. The water sensor lead 21 detects the presence of water at a single location and are useful for detecting a puddle of water which may form a low spot. Cable sensor leads 24 and tape sensor leads 25 operate to detect leaks with a specified area. They may be used along pipes or around water heaters or other devices which could leak at various positions. Different types of tape sensor leads 25, such as fabric tape and stainless steel tape, are known. FIG. 2D illustrates a non-water sensor lead. It may be of several known types, including temperature sensors, gas sensors or carbon monoxide sensors. The sensor lead 26 includes a detector 26a at an end away from the sensor 20. The detector 26a is designed in a known manner for the desired type of detection. As with other sensor leads, when the detected condition is present, the detector 26a completes an electrical circuit within the sensor 20.

As illustrated in FIG. 1, the controller 30 includes a housing 39 for containing circuitry. Since the controller need not be placed near the location of a leak, the housing 39 may not be water tight. Furthermore, since various connections, switches and indicator lamps are used in the controller 30, making the housing 39 water tight would be unnecessarily expensive due to the use of multiple seals and sealing surfaces.

The controller 30 includes a plurality of output ports 31, 32. The output ports 31, 32 are used to output signals for controlling the status of valves or other mechanical devices. While the controller 30 is illustrated in FIG. 1 as including two output ports 31, 32, any number of output ports may be used. The number of output ports used in the system 10 would depend upon the number of devices to be controlled.

As illustrated in FIG. 1, a first controllable valve 41 is placed in a pipe 45. The controllable valve 41 is opened and closed by providing signals on control line 47. The controllable valve 41 may be of any known type. It may include a ball valve and/or a solenoid operator, as is known in the art. A second controllable valve 42 is positioned in a second pipe 46. The second controllable valve 42 is operated with a control signal on line 48. The pipes 45, 46 may carry water, natural gas, oil, propane or any other liquid or gas. The pipes 45,46 may carry the same material or may have different materials. Furthermore, the system of the present invention is not limited to control of two valves or even to valves. Any number of output ports 31, 32 may be used and the control signals from the output ports 31, 32 may be connected to any type of controllable device, including motors and electrical relays as well as valves.

The controller 30 includes one or more LED indicator lights 35 for identifying the status or condition of the controller 30 and the system 10. For example, the LEDs 35 may be used to indicate that one or more valves have been shut off. The controller 30 further includes a plurality of switches 36, 37, 38 for manually performing various functions. For example, the controller 30 may include an audio alarm. One of the switches 36, 37, 38 may be used to shut off the audio alarm. In this manner, an operator or repairman may acknowledge and stop an alarm without having to first correct the condition which resulted in the alarm. Switches 36, 37, 38 may also be used for opening or closing the controlled valves, irrespective of the status of the controller. Thus, the controller 30 may be used to manually shut off the water supply, when a leak has not been detected, so that some service may be performed. Alternatively, the controller 30 may be used to reopen the water supply line after a leak detection by using the switches 36, 37, 38.

Upon receipt of a signal from a sensor 20, the controller sends a control signal through either or both outputs 31, 32 to close the valves 41, 42, as appropriate. Which valves are closed by the controller depends upon the nature and location of the detected leak or condition. Each sensor 20 includes an identifier. Each identifier within the system is associated with a desired action or actions within the controller 30. When a sensor transmits a signal upon detection of a leak or other condition, the identifier for that sensor 20 is included in the signal. The controller determines the identifier in the signal and performs the actions associated with that identifier. Thus, the system of the present invention can provide varied responses to different detected conditions.

For example, as is known in prior art systems, water sensors 20 may be placed at locations throughout a building where leaks are likely to occur. A controllable valve may be placed on the water input line to the building. Upon detection of a water leak by any of the sensors 20, a signal which includes an identifier is sent from the sensor 20 to the controller 30. The controller 30 determines that the identifier corresponds to a water sensor and sends a control signal through an output 31, 32 to the controllable valve shutting off all water to the building.

While shutting off the water may be sufficient for pipe, fixture or dishwasher leaks, it is not a proper response to a water heater leak. In addition to shutting off the water, the water heater needs to be completely shut down. This includes shutting off the power to the water heater. Shutting off the power may include shutting off gas to the heater as well as electricity to the water heater control, so that it doesn't try to turn on the water heater without water or gas. Prior art systems could not accommodate a water heater with a system for detecting general water leaks. In order to fully respond to a water heater leak, a separate system would be used for the water heater. This, of course, would necessitate a second valve in the water input line for shutting off water.

According to an embodiment of the present invention, the controller 30 may be connected to a water line 45 and a gas line 46. When a general water leak occurs, the controller 30 shuts off valve 41 to stop the flow of water. However, when the identifier for a sensor for the water heater is received, the controller 30 responds by operating both the water valve 41 and the gas valve 42. In this manner, a water heater leak can be responded to appropriately by the same system which responds to other types of water leaks.

Through the flexible relation of actions to detected conditions, the system of the present invention may be used to respond in various ways to different types of conditions. If a high level of carbon monoxide is detected by an appropriate sensor in the system, the controller 30, upon receipt of the identifier for that sensor, may shut off the valve 42 connected to the gas line. While carbon monoxide may have resulted from the water heater, shutting off the gas line is a sufficient response to the detected problem. The water line 45 does not have to be shut off for this condition.

The system of the present invention may also be used to monitor and control buildings with multiple units. Sensors can be placed at likely locations for leaks throughout all of the units in the building. A single controller 30 is placed near the water source lines for all of the units, typically in the basement of the building. When a leak is detected by a sensor, the identifier for that sensor corresponds in the controller 30 to one of the units. The valve corresponding to only that unit is shut off. The water supply to the other units are not affected.

By using different kinds of sensors, the flexibility of the system of the present invention can be utilized to protect against different types of threats. The system can also turn on devices as well as turning them off. Thus, it can respond to conditions to take action as well as to stop something causing damage. For example, the system may turn on a sump pump to remove accumulated water, whether from a leak or from a flooding condition.

Temperature sensors may be used on pipes which might freeze. When the temperature sensor detects a low temperature condition, the controller 30 may respond by turning on a heater, either a space heater or a pipe heater, to increase the temperature of the pipe. Temperature sensors may also be used to control an air conditioning system to prevent excessive temperatures which may cause mold or mildew growth. Humidity sensors may also be used in connection with air conditioner control to prevent unwanted mold or mildew. Furthermore, electrical sensors may be used to determine when power has been lost to the building. Without power, attempting to turn on a heater or an air conditioner to correct a detected problem would be futile. Different actions can be accommodated by the system of the present invention depending upon these detected conditions.

According to an embodiment of the present invention, the system 10 provides notification of the detected conditions through a variety of mechanisms. The controller 30 includes an audio alarm which is activated when an abnormal condition is detected. It may also include a visual alarm, either using the LEDs or another light (not shown). However, if the controller 30 is not placed in a location of consistent personnel presence, alarms are not helpful.

The controller 30 may be connected by an output 33 to an autodialer 50. Autodialer 50 may be of conventional design. It includes a keypad 53 for inputting and storing numbers to be called. It also includes a display 52. The autodialer 50 is connected to a telephone line 51 for the building. The autodialer is programmed to telephone one or more telephone numbers upon receipt of a signal from the controller 30. The numbers may be prestored in the autodialer 50 using the keypad 53 or may be transmitted by the controller 30. When a telephone connection is made, the autodialer 50 plays a recorded message. The message may be prerecorded by the user or may be transmitted from the controller 30. The controller 30 can be used to provide case specific notifications using the autodialer 50. For example, the controller 30 may have the autodialer 50 telephone a plumber when a water leak is detected and the gas company when a gas leak is detected. The autodialer 50 may also telephone the building owner or manager. The autodialer 50 may include one or more additional ports 54 for connecting it to other devices, such as computer. The port 54 may be used in programming the autodialer or for transferring notifications to a computer.

According to an embodiment of the present invention, the controller 30 may be connected to another device for notification purposes. An autodialer may be used to call a phone or pager. Other devices can sent text messages or emails for notifying owners or service personnel of detected conditions.

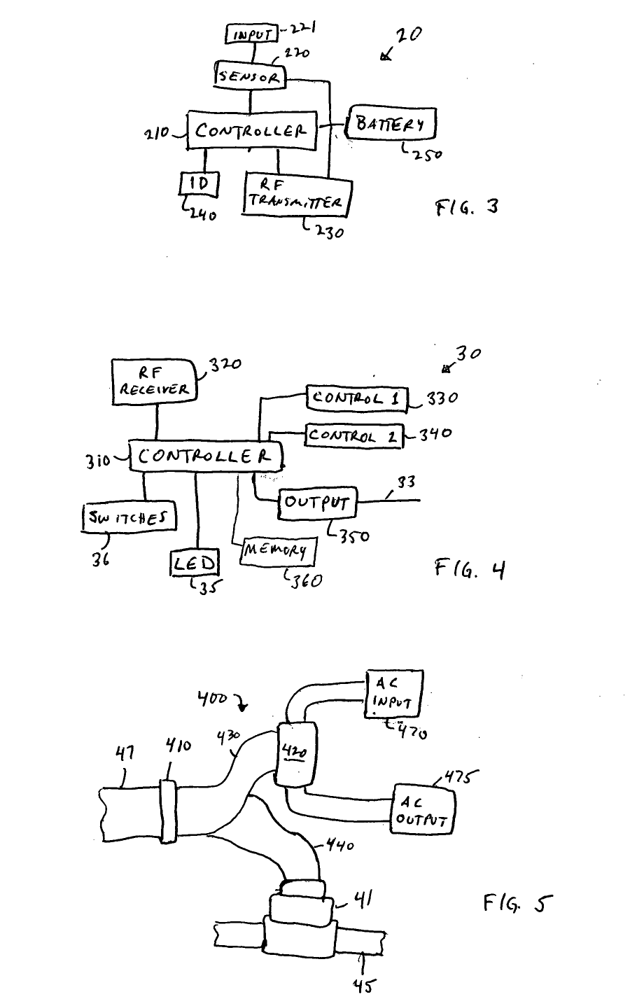

FIG. 3 illustrates the components of a sensor 20 according to an embodiment of the present invention. The sensor 20 is implemented with circuitry, either digital or analog, in order to perform the desired functions. Preferably, the sensor 20 includes a controller 210 such as a microprocessor or special purpose processor for controlling the sensor 20 and performing the necessary operations. The controller 210 is connected to a sensor 220. The sensor 220 is a circuit which determines whether a completed electrical circuit is present at the input 221. The input 221 is connected to the sensor lead through the port 29 of the sensor. The controller is also connected to an RF transmitter 230. When the sensor 220 detects a completed circuit, a signal is provided to the controller 210. The controller sends a signal using the RF transmitter 230 of the sensed condition. The components of the sensor 20 are powered by a battery 250. Preferably, the battery is a long-lasting, lithium battery, so that it does not need to be changed very often. Alternatively, the sensor 20 could be wired to the building power supply instead of a battery. However, a battery should still be included as a backup power source in the event of power failure at the building. Since leaks can often be caused by conditions resulting from loss of electrical power in a building, the system 10 should remain operational even in the even of power failures.

Since the controller 30 performs actions based upon the location or type of sensor which detects a specific condition, each sensor needs to be uniquely identified. Sensor 20 includes an ID 240 which may be unique to that sensor. In an embodiment of the invention, the ID is set using eight DIP switches in the sensor 20. The controller 210 of the sensor 20 reads the ID240 as set with the DIP switches and transmits the ID with the condition signal on the RF transmitter 230. Alternatively, the ID 240 may be stored in a memory associated with the controller 210. The memory may be programmed using inputs (not shown) to the controller 210. Such inputs may be switches on the sensor 20 or may be a port for connecting the sensor to another device for programming. Additionally, the ID could be preset when the sensor is manufactured. The ID may be unique to each sensor or several sensors may use the same ID. If the same action is to be taken in response to a signal from one of several different sensors 20, then all of those sensors can include the same ID.

FIG. 4 illustrates the components of the controller 30. The controller 30 also includes a controller 310 for performing the desired operations. The controller 310 is a microprocessor or specially programmed processor. A memory 360 stores the programs to be executed by the controller 310. An RF receiver 320 is connected to the controller 310 for receiving signals from the sensors 20. Upon receipt of a signal at the RF receiver 320, the controller 310 accesses the memory 360 to determine the proper action to be taken. The actions may be stored in the memory 360 in any known manner. According to an embodiment of the invention, the actions are stored in a table format. Each entry in the table includes an identifier and an action. The action can be as simple as which signal lines to activate or may include complex instructions such as telephone numbers to dial and messages to transmit.

The controller 310 is connected to several output lines. Two output lines connect to controls 1 and 2 330, 340. Controls 1 and 2 330, 340 provide outputs to the ports 31, 32 to the controllable valves. Based upon the actions stored in memory 360, control 1, control 2 or both may be activated by the controller 310. Another output 350 connects to the line 33 to the autodialer 50. The output 350 may simply signal the autodialer 50 to perform its programmed process. Alternatively, the output 350 may provide telephone numbers and messages from the memory 360 to the autodialer 50. Of course, other outputs can be used either for control or notification. The switches 36 and LEDs 35 are also connected to and operable with the controller 310.

In some instances, several actions are always performed simultaneously. For example, for buildings with a well as a water source, it is not sufficient to merely close a valve. A well based system includes a pump and water pressure troll. When water is used in such a system, the water pressure troll operates the pump to maintain a relatively constant pressure in the system. When water is used, the pressure drops and the pump turns on. However, when a water input valve is shut off due to a detected leak, the pressure troll and pump seek to maintain the pressure in the system. Operation of the pump does not increase the pressure in the system due to the shut valve. This situation can damage the pump. Therefore, the pump and pressure troll need to be shut off when the valve is closed. According to an embodiment of the present invention, these steps can be performed by a single control output 47 from the controller 30 using a control splitter 400 as illustrated in FIG. 5. The control splitter 400 includes a connector 410 and two outputs 430, 440. The connector 410 connects to the output 47 from the controller. One output 440 connects to the controllable valve 41. The controllable valve 41 receives a signal through the output 440 in the same manner as if from the controller output 47 and closes the valve. Output 430 connects to an electrical relay 420. The signal from the controller output 47 is transferred to the relay 420 through the connector 410 and the output 430. The relay 420 is positioned between an AC input 470 and an AC output 475. The pressure troll and pump receive power from the AC output. When the valve 41 is closed with the signal from the controller output 47, the relay 420 also disconnects the AC output 475 from the AC input 470. In this manner, the pressure troll and pump are shut off at the same time that the valve is closed.

The output splitter may be used in a similar manner in connection with other actions. For example, the electrical control of a boiler can be shut off when a valve on the gas line is closed. Additionally, the output splitter may be used for controlling two valves with a single signal, instead of a valve and a relay.

Having described at least one embodiment of the invention, various modifications, adaptations, additions and extensions will be readily apparent to those of skill in the art. Such modifications, adaptations, additions and extensions are considered to be within the scope of the invention, which is not limited except as to the claims hereto.

1. An automated environmental response system for a building comprising:
a plurality of sensors, each sensor transmitting a respective signal upon occurrence of a sensed environmental condition within the building;
a plurality of actuators controlling operation of the building; and
a controller, receiving signals from the plurality of sensors, selecting and operating at least one of the plurality of actuators based upon a signal from at least one of the plurality of sensors.

2. The automated environmental response system according to claim 1, wherein each sensor transmits an identifier as part of a respective signal; and
wherein the controller selects the at least one of the plurality of actuators based upon an identifier in a received signal.

3. The automated environmental response system according to claim 1, wherein the controller selects and operates a first set of the plurality of actuators in response to a signal from a first one of the plurality of sensors, and select and operates a second set of the plurality of actuators in response to a signal from a second one of the plurality of sensors.

4. The automated environmental response system according to claim 3, wherein the first set of the plurality of actuators includes at least one actuator which is not part of the second set of the plurality of actuators.

5. The automated environmental response system according to claim 1, wherein at least one of the plurality of sensors includes a plurality of sensing leads.

6. The automated environmental response system according to claim 1, wherein at least one of the plurality of actuators is an autodialer.

7. The automated environmental response system according to claim 1, wherein at least one of the plurality of actuators is a valve in a water pipe.

8. The automated environmental response system according to claim 7, wherein at least one of the sensors is a water sensor.

9. The automated environmental response system according to claim 1, wherein the signals are RF transmissions.

10. The automated environmental response system according to claim 1, wherein the controller is programmable such that each signal from a sensor is associated with at least one of the plurality of actuators.

11. The automated environmental response system according to claim 1, wherein the controller outputs a control signal to operate the actuators; the system further comprising:
a control signal splitter providing a single control signal from the controller to at least two of the plurality of actuators.

12. A method for responding to a plurality of sensed environmental conditions within a building comprising the steps of:
associating each of the plurality of sensed environmental conditions with at least one of a plurality of actions relating to operation of the building;
sensing one of the plurality of sensed environmental conditions; and
performing the at least one of the plurality of actions based upon the sensed condition.

13. The method for responding to a plurality of sensed environmental conditions according to claim 12, wherein at least one of the sensed environmental conditions is the presence of water and wherein at least one of the plurality of actions is shutting off a water source.

14. The method for responding to a plurality of sensed environmental conditions according to claim 12, wherein a first subset of the plurality of actions is associated with a first sensed condition and a second subset of the plurality of actions is associated with a second sensed condition.

15. The method for responding to a plurality of sensed environmental conditions according to claim 14, wherein the first subset of the plurality of actions includes at least one action which is not part of the second subset of the plurality of actions.

16. The method for responding to a plurality of sensed environmental conditions according to claim 12, wherein at least one of the plurality of actions is activation of an autodialer.
